(19) United States
(12) Patent Application Publication
(10) Pub. No.: US 2018/0348002 A1
(43) Pub. Date: Dec. 6, 2018

(54) PROVIDING EASE-OF-DRIVE DRIVING DIRECTIONS

(71) Applicant: International Business Machines Corporation, Armonk, NY (US)

(72) Inventors: Charu C. Aggarwal, Yorktown Heights, NY (US); Saket K. Sathe, Mohegan Lake, NY (US); Deepak S. Turaga, Elmsford, NY (US)

(21) Appl. No.: 15/811,732

(22) Filed: Nov. 14, 2017

Related U.S. Application Data
(63) Continuation of application No. 15/609,756, filed on May 31, 2017.

(51) Int. Cl. G01C 21/36; G01C 21/34

(52) U.S. Cl. CPC G01C 21/3626; G01C 21/3605; G01C 21/3492

(57) ABSTRACT

Embodiments of the invention include method, systems and computer program products for providing ease-of-drive driving directions. The computer-implemented method includes receiving, by a processor, a request for a route from a starting point to a destination point. The processor calculates one or more routes from the starting point to the destination point. The processor scores the one or more calculated routes according to ease-of-drive driving criteria. The processor presents at least one of the scored calculated routes that are below a predetermined threshold.

This application is a continuation of U.S. patent application Ser. No. 15/609,756, entitled “PROVIDING EASE-OF-DRIVE DRIVING DIRECTIONS,” filed May 31, 2017, the disclosure of which is incorporated by reference herein in its entirety.

### BACKGROUND

The present invention relates in general to mobile navigation, and more specifically, to proving directions based on an ease of traversing a route.

In general, navigation systems allow a user or operator to enter a starting point and a destination point. The navigation system may access a map database containing road information. The navigation system may use the starting point, destination point and the map database to compute one or more routes from the starting point to the destination point. The navigation system may then present one or more of the computed routes to a user. The presented routes are usually based on a fastest route or shortest route distance.

### SUMMARY

Embodiments of the invention are directed to a method for providing ease-of-drive driving directions. A non-limiting example of the computer-implemented method includes receiving, by a processor, a request for a route from a starting point to a destination point. The processor calculates one or more routes from the starting point to the destination point. The processor scores the one or more calculated routes according to ease-of-drive driving criteria. The processor presents at least one of the scored calculated routes that are below a predetermined threshold.

Embodiments of the invention are directed to a computer program product that can include a storage medium readable by a processing circuit that can store instructions for execution by the processing circuit for performing a method for providing ease-of-drive driving directions. The method includes receiving a request for a route from a starting point to a destination point. The processor calculates one or more routes from the starting point to the destination point. The processor scores the one or more calculated routes according to ease-of-drive driving criteria. The processor presents at least one of the scored calculated routes that are below a predetermined threshold.

Embodiments of the invention are directed to a system for providing ease-of-drive driving directions. The system can include a processor in communication with one or more types of memory. The processor can be configured to receive a request for a route from a starting point to a destination point. The processor can be further configured to calculate one or more routes from the starting point to the destination point. The processor can be further configured to score the one or more calculated routes according to ease-of-drive driving criteria. The processor can be further configured to present at least one of the scored calculated routes that are below a predetermined threshold.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The subject matter that is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a diagram illustrating an exemplary operating environment according to one or more embodiments of the present invention;

FIG. 2 is a block diagram illustrating one example of a portion of the processing system one or more computing devices described in FIG. 1 for practice of the teachings herein;

FIG. 3 illustrates an exemplary road network and route scoring according to one or more embodiments of the present invention; and

FIG. 4 is a flow diagram illustrating a method for ease-of-drive route scoring according to one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. In addition, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments of the invention, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, which are related to providing driving directions. In general, computerized navigation systems allow a user or operator to enter a starting point and a destination point and receive a calculated route from the starting point to the destination point. The calculated route can be based on additional considerations, for example, traffic predictions, live traffic updates, historical information, driver preferences, or the like. The calculated route is often based on a fastest time (fastest) or a shortest distance (shortest) route.

In addition to the fastest time or shortest distance route, driver preferences can include a variety of options for the driver that can be used to calculate a preferred route. For example, the driver can choose to avoid certain road structures (tolls, unpaved roads, and ferries), road types (highways or unpaved roads) or maneuvers (U-turns).

Calculated routes can involve many maneuvers, complex maneuvers and/or require a driver to drive on a complex portion of a road network, for example, large highways, roundabouts, multi-highway interchanges or the like. While current calculated routes can consider a set of user preferences, these user preferences fail to take into account a skill or comfort level associated with a driver or driver familiarity with the area covered by the route.

Turning now to an overview of aspects of the invention, one or more embodiments of the invention address the above-described shortcomings of the prior art by providing ease-of-drive driving directions. A new routing criterion provides a driver with driving directions that are less complex than an optimal route (fastest or shortest calculated routes) but remains within an acceptable amount of delay in consideration of optimal route.

The above-described aspects of the invention address the shortcomings of the prior art by accounting for a drivers skill or comfort with traveling through an area in which driving directions are provided by scoring each calculated route according to an ease of driving for the calculated route. Accordingly, a route can be provided to a user that is simpler (i.e., less maneuvers, lane changes, etc.) even though the provided route may not be the fastest or shortest route.

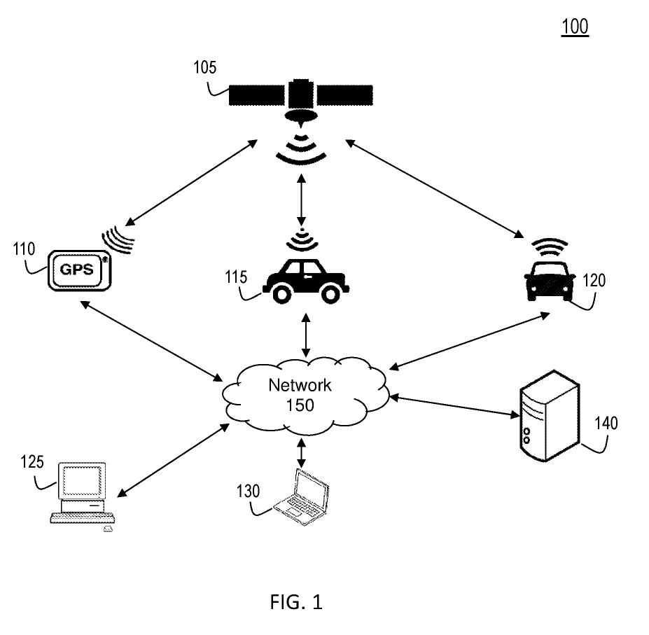

FIG. 1 is a block diagram illustrating an operating environment 100 according to one or more embodiments of the present invention. The environment 100 can include a plurality of global positioning satellites (GPS) 105 that transmit location signals to a plurality of vehicles and mobile devices 115, 120 and 110. Each of the vehicles and mobile devices 115, 120 and 110 includes a GPS transmitter/receiver (not shown) which is operable for receiving location signals from the plurality of GPS satellites 105 that provide signals representative of the location of each vehicle or mobile device, respectively. In addition to the GPS system, each vehicle 115, 120 and mobile device 110, includes a navigation processing system which is arranged to communicate with a server 140 through an communications network 150, for example, the Internet or another type of data connection. Accordingly, vehicles and mobile devices 115, 120 and 110 are able to determine a location/route information and transmit that location/route information to the server 140 where the vehicle and mobile device location information are tracked and stored. The server 140 can use the received location points received from the vehicles and mobile devices 115, 120 and 110 to develop travel routes, which are also stored and made available to other vehicles and mobile device users who access the server 140.

The environment 100 can also include one or more computing devices 125 and 130. A user can use the one or more computing devices 125 and 130 to access server 140 via network 150 in order to obtain a calculated route from a starting point to a destination point.

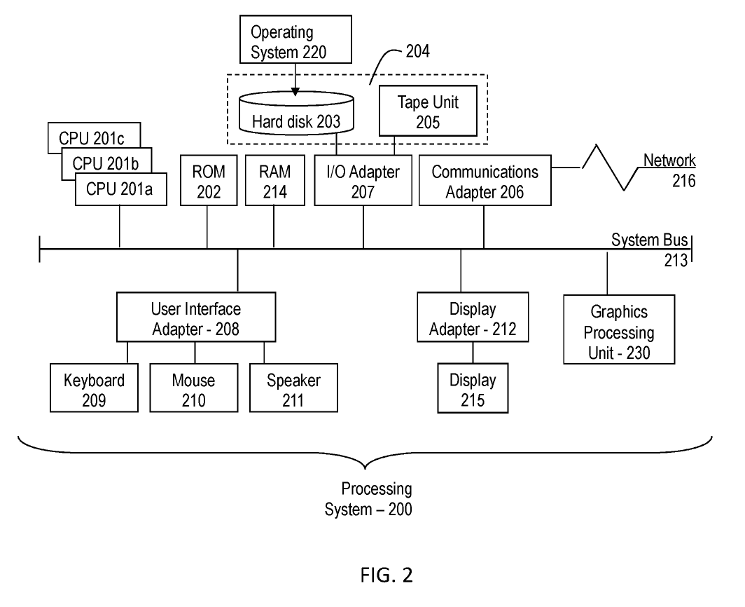

Referring to FIG. 2, there is shown an embodiment of a processing system 200 for implementing the teachings herein. The processing system 200 can form at least a portion of one or more computing devices 125 and 130 and server 140. In this embodiment, the processing system 200 has one or more central processing units (processors) 201a, 201b, 201c, etc. (collectively or generically referred to as processor(s) 201). In one embodiment, each processor 201 may include a reduced instruction set computer (RISC) microprocessor. Processors 201 are coupled to system memory 214 and various other components via a system bus 213. Read only memory (ROM) 202 is coupled to the system bus 213 and may include a basic input/output system (BIOS), which controls certain basic functions of the processing system 200.

FIG. 2 further depicts an input/output (I/O) adapter 207 and a network adapter 206 coupled to the system bus 213. I/O adapter 207 may be a small computer system interface (SCSI) adapter that communicates with a hard disk 203 and/or tape storage drive 205 or any other similar component. I/O adapter 207, hard disk 203, and tape storage device 205 are collectively referred to herein as mass storage 204. Operating system 220 for execution on the processing system 200 may be stored in mass storage 204. A network adapter 206 interconnects bus 213 with an outside network 216 enabling data processing system 200 to communicate with other such systems. A screen (e.g., a display monitor) 215 can be connected to system bus 213 by display adaptor 212, which may include a graphics adapter to improve the performance of graphics intensive applications and a video controller. In one embodiment, adapters 207, 206, and 212 may be connected to one or more I/O busses that are connected to system bus 213 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 213 via user interface adapter 208 and display adapter 212. A keyboard 209, mouse 210, and speaker 211 can all be interconnected to bus 213 via user interface adapter 208, which may include, for example, a Super I/O chip integrating multiple device adapters into a single integrated circuit.

In exemplary embodiments, the processing system 200 includes a graphics-processing unit 230. Graphics processing unit 230 is a specialized electronic circuit designed to manipulate and alter memory to accelerate the creation of images in a frame buffer intended for output to a display. In general, graphics-processing unit 230 is very efficient at manipulating computer graphics and image processing, and has a highly parallel structure that makes it more effective than general-purpose CPUs for algorithms where processing of large blocks of data is done in parallel.

Thus, as configured in FIG. 2, the processing system 200 includes processing capability in the form of processors 201, storage capability including system memory 214 and mass storage 204, input means such as keyboard 209 and mouse 210, and output capability including speaker 211 and display 215. In one embodiment, a portion of system memory 214 and mass storage 204 collectively store an operating system to coordinate the functions of the various components shown in FIG. 2.

The server 140 may further include a transmitter and receiver (not shown), to transmit and send information to and from one or more vehicles and/or mobile devices 115, 120 and 110. The signals sent and received may include data, communication, and/or other propagated signals. Further, it should be noted that the functions of transmitter and receiver could be combined into a signal transceiver.

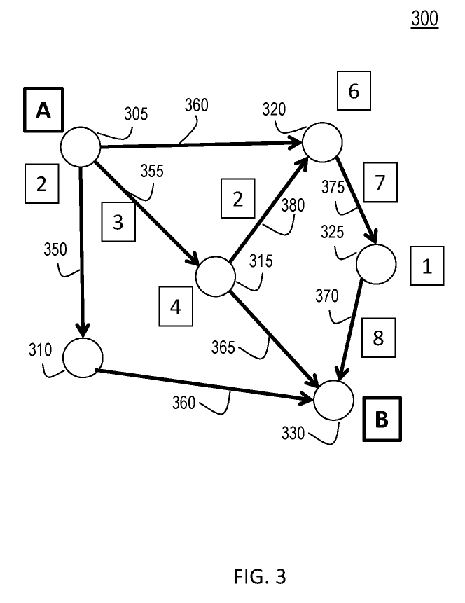

FIG. 3 illustrates an exemplary road network 300 and route scoring according to one or more embodiments of the present invention. The exemplary route scoring is based on a user seeking a route from A (305) to B (330). Upon receipt of a route request from a user through vehicles (115 and 120) and/or mobile devices 110 and/or one or more computing devices 125 and 130 via a receiver, the server 140 can use processor 201 to calculate one or more routes from A to B. The vehicles and mobile devices 115, 120 and 110 and the one or more computing devices 125 and 130 can also calculate the one or more routes from A to B.

The calculated one or more routes can be ordered by time, for example, the route from A to B with the fastest time is listed first. The ordered list of routes can then be scored by the processor 201 based on ease of driving.

In road network 300, each route of the ordered list comprises road segments (350, 355, 360, 365, 370, 375 and 380) and road transitions (305, 310, 315, 320, 325 and 330). Each road transition and road segment can have a score from 1 to 10, for example, with 10 being easiest and 1 being hardest.

Scoring can be based on a variety of factors, for example, a type of maneuver required, type of road segment, weather, number of lane changes, number of turns, number of lanes on a road, average number of accidents on a road or at a location, road gradient or slope, current traffic conditions, historical traffic conditions, or the like. Maneuvers that are more difficult can be scored lower. How maneuvers are scored can be dependent on location. For example, in the United States, a left turn or U-turn would have a lower score than turning right or proceeding straight. For example, driving through a roundabout or a route requires a large amount of lane changes or turns would have a lower score than a route having a straight path with few turns.

Upon the processor 201 scoring the road transitions and road segments from A to B depicted in FIG. 3, a route from transition 305 to transition 315 to transition 320 to transition 325 and transition 330 can have a calculated score of 33. For example, the route having a score of 33 can be the highest scoring route of the scored routes in the ordered list. Accordingly, the route having the score of 33 can be determined to be the easiest route from A to B. The ordered list based on fastest travel time can be re-ordered based on an associated ease-of-drive driving score for each route.

While a user may desire the easiest route from A to B, even if an easiest route is longer than the fastest route, there is usually a limit of how much of a delay in light of the fastest route the user will accept. Accordingly, the processor 201 of server 140 can compare each scored route or each calculated route to a threshold. For example, the server can compare routes to the time calculated for the fastest route and discard routes that are a percentage (P) of time greater than the fastest route. Accordingly, if a route takes, for example, 10% longer in time than the fastest route, the route can be discarded. The percentage can be set by the route providers or by the user in an associated listing of user preferences. If routes that are easier than the fastest route are still listed after the comparison to the fastest route, these routes can be presented to the user listed by ease-of-drive driving score.

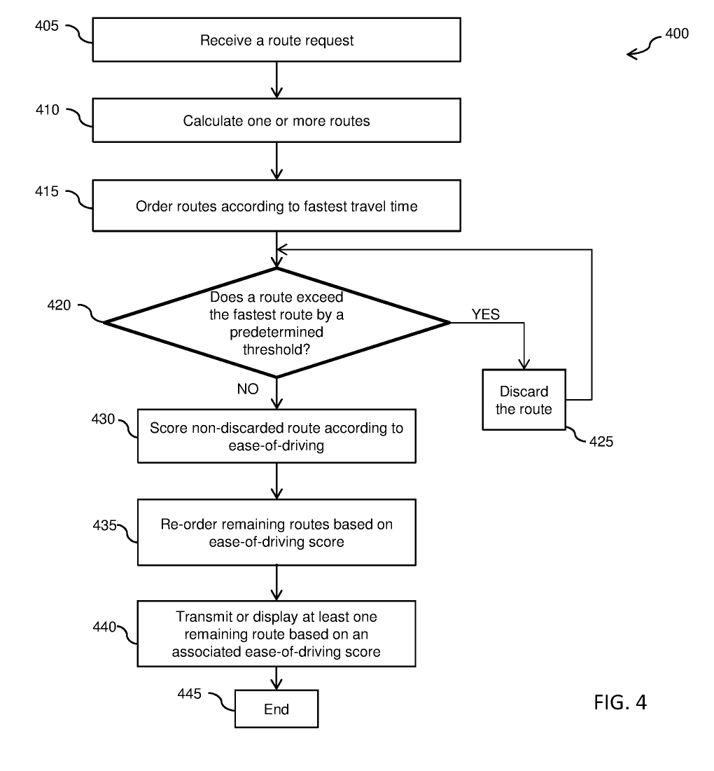

FIG. 4 is a flow diagram illustrating a method 400 of providing ease-of-drive driving directions according to one or more embodiments of the present invention. At block 405, the server 140 receives, via a receiver or network 150, a request for a route from a starting point to a destination point. The server 140 can receive the request from one or more vehicles (115 and 120) and/or mobile devices 110 and/or one or more computing devices 125 and 130. At block 410, a processor 201 of the server 140 can calculate one or more routes from the starting point to the destination point. At block 415, the processor 201 can order the one or more routes according to shortest time (fastest) to travel from the starting point to the destination point. At block 420, the processor 201 can determine which routes of the one or more routes from the starting point to the destination point exceed the fastest by a predetermined threshold, for example, a percentage (10%). The predetermined threshold can also be related to a comparison of a shortest route. The percentage can be set by the route provider or the user. At block 425, the processor 201 can discard the routes that exceed the predetermined percentage. At block 430, the one or more routes that have not be discarded at block 425 can be scored by the processor 201 according to ease of driving. The scoring of the one or more routes can occur before block 425. At block 435, the processor 201 can reorder the one or more non-discarded routes according to an associated ease-of-drive driving score. At block 440, the processor 201 can send, via a transmitter of server 140 and network 150, at least one route to the one or more requesting vehicles (115 and 120) and/or mobile devices 110 and/or one or more computing devices 125 and 130 based on an associated ease-of-drive driving score, for example, the route having the highest ease-of-drive driving score, for subsequent viewing. If method 400 occurs in the one or more requesting vehicles (115 and 120) or on mobile devices 110 or on one or more computing devices 125 and 130, at least one route can be displayed based on an associated ease-of-drive driving score, for example, the route having the highest ease-of-drive driving score. At block 445, the method 400 ends.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for providing ease-of-drive driving directions, the method comprising:
receiving, by a processor, a request for a route from a starting point to a destination point;
calculating, by the processor, one or more routes from the starting point to the destination point;
scoring, by the processor, the one or more calculated routes according to ease-of-drive driving criteria; and
presenting, by the processor, at least one of the scored calculated routes that are below a predetermined threshold.

2. The computer-implemented method of claim 1, wherein the predetermined threshold is determined by comparing each of the one or more calculated routes to a determined optimal route of the one or more routes.

3. The computer-implemented method of claim 1, wherein the one or more routes above the predetermined threshold are discarded.

4. The computer-implemented method of claim 1, wherein presenting at least one of the scored calculated routes comprises transmitting the portion of the ordered list to at least one of the following: a vehicle, a mobile device or a computing device.

5. The computer-implemented method of claim 1, wherein presenting at least one of the scored calculated routes comprises displaying the portion of the ordered list to at least one of the following: a vehicle, a mobile device or a computing device.

6. The computer-implemented method of claim 1, wherein scoring the one or more routes is based on at least one of the following: a type of maneuver required, type of road segment, weather, number of lane changes, number of turns, number of lanes on a road, average number of accidents on a road or at a location, road gradient or slope, current traffic conditions, or historical traffic conditions.

7. The computer-implemented method of claim 1, wherein scoring the non-discarded one or more routes scores each road transition and each road segment for each route of the one or more routes.

8. The computer-implemented method of claim 1 further comprising ordering each of the one or more routes according to an associated ease-of-drive driving score, wherein the at least one of the scored calculated routes presented is an easiest route of the ordered list.
